(19) United States
(12) Patent Application Publication
(10) Pub. No.: US 2026/0129306 A1
(43) Pub. Date: May 7, 2026

(54) SYSTEM, CONTROL METHOD AND NON-TRANSITORY COMPUTER READABLE MEDIUM

(71) Applicant: CANON KABUSHIKI KAISHA, Tokyo (JP)

(72) Inventor: SHO MIYAZAKI, Kanagawa (JP)

(21) Appl. No.: 19/372,716

(22) Filed: Oct. 29, 2025

(30) Foreign Application Priority Data
Nov. 5, 2024 (JP) 2024-193615

(51) Int. Cl. H04N 23/74; H04N 23/56

(52) U.S. Cl. CPC H04N 23/74; H04N 23/56

(57) ABSTRACT

A system controls a first strobe that irradiates an object imaged by an imaging device with light. The system includes: a processor; and a memory storing a program which, when executed by the processor, causes the system to: execute information control processing for storing, in a storage portion, position information regarding a position of a second strobe and setting information of the second strobe in a case where the imaging device is performing imaging using light emitted from the second strobe at a first time; and execute transmission processing for transmitting, to the first strobe, information based on the position information and the setting information stored in the storage portion in a case where the first strobe irradiates the object with light at a second time after the first time.

### BACKGROUND

### Field of the Technology

The present disclosure relates to a system for controlling a strobe, a control method and a non-transitory computer readable medium.

### Description of the Related Art

In a case where there is an interval between photographing dates or in a case where photographing is performed by changing the location, a rough distance between an object and the strobe may be recorded in order to reproduce the arrangement of the strobe (light-emitting device). Then, the user performs photographing at the time of reproduction on the basis of the recorded distance. At this time, the user performs fine adjustment while confirming the image.

In addition, a general user who intends to imitate an image captured by a professional performs trial and error such as repeating photographing by estimating the arrangement of the strobe with which photographing has been performed. For this reason, it is very difficult to reproduce the arrangement of the strobe at the time of photographing, and there is difficulty in ensuring consistency in photographing. Japanese Patent Laid-Open No. 2020-181019 describes a technique for storing a position of a strobe after the strobe is arranged.

Japanese Patent Laid-Open No. 2020-181019 aims to prevent positional deviation by storing an absolute position of an installed strobe and notifying a user of a deviation amount from the absolute position. For this reason, in Japanese Patent Laid-Open No. 2020-181019, for example, in a case where the strobe to be used is changed or the position of the object is changed, the effect due to past light emission of a strobe with respect to the object may not be able to be reproduced.

### SUMMARY

The present disclosure provides a technique for more faithfully reproducing an effect due to past light emission of a strobe with respect to the object.

One embodiment of the present disclosure is a system that controls a first strobe that irradiates an object imaged by an imaging device with light, the system including: a processor; and a memory storing a program which, when executed by the processor, causes the system to: execute information control processing for storing, in a storage portion, position information regarding a position of a second strobe and setting information of the second strobe in a case where the imaging device is performing imaging using light emitted from the second strobe at a first time; and execute transmission processing for transmitting, to the first strobe, information based on the position information and the setting information stored in the storage portion in a case where the first strobe irradiates the object with light at a second time after the first time.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a camera strobe system.

FIG. 2 is a configuration diagram of a UWB device.

FIG. 3 is a sequence diagram for explaining distance measurement by the UWB device.

FIG. 4 is a diagram illustrating measurement of an angle of the UWB device.

FIG. 5 is a diagram for explaining three-lamp illumination.

FIG. 6 is a diagram illustrating position information.

FIG. 7A is a flowchart of transmission processing of position information.

FIG. 7B is a flowchart of transmission processing of position information.

FIG. 8 is a diagram illustrating a setting value table describing information related to the setting of the strobe.

FIG. 9 is a diagram illustrating a setting value table describing position information of a receiver strobe.

FIG. 10 is a diagram illustrating display items displayed on a display unit.

### DESCRIPTION OF THE EMBODIMENTS

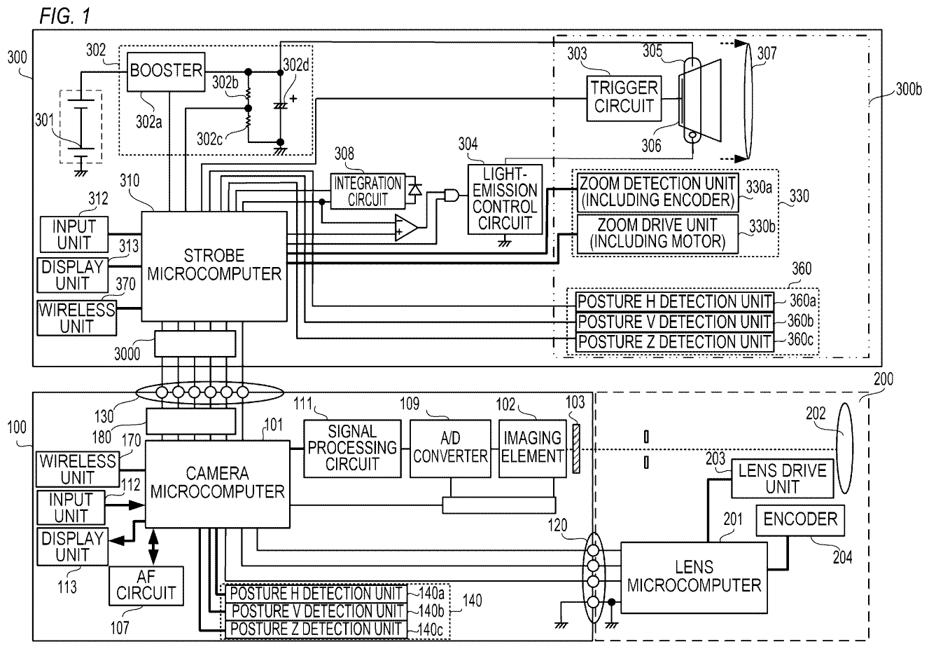

Hereinafter, a schematic configuration of a camera strobe system according to a first embodiment will be described with reference to FIG. 1.

The camera strobe system includes a camera 100, a lens unit 200, and a strobe 300. The camera 100 is an imaging device. The lens unit 200 is detachably attached to the camera 100. The strobe 300 is a strobe detachably attached to the camera 100. The strobe 300 can be used also as a sender strobe that sends a signal from the camera 100 to a receiver strobe or as a receiver strobe that emits light according to the signal. Therefore, in the camera strobe system, one of a plurality of strobes 300 operates as the sender strobe, and the other strobe 300 operates as the receiver strobe. FIG. 1 illustrates a case where the strobe 300 is used as a receiver strobe.

The camera 100 and the lens unit 200 and the camera 100 and the strobe 300 are connected by a communication line (signal line). The communication lines mutually perform communication of information such as exchange of data or transmission of a command with a camera microcomputer 101 as a host (host in a host device relationship), for example.

(Configuration of Camera Body) A configuration of the camera 100 will be described. The camera 100 includes a camera microcomputer 101, an imaging element 102, a shutter 103, an autofocus (AF) circuit 107, an A/D converter 109, and a signal processing circuit 111. The camera 100 includes an input unit 112, a display unit 113, a terminal 120, a terminal 130, a posture detection circuit 140, a wireless unit 170, and a camera interface circuit 180.

The camera microcomputer 101 is a microcomputer CPU (control unit) that controls each unit of the camera 100. The camera microcomputer 101 is, for example, a one-chip IC circuit incorporating a microcomputer. The camera microcomputer 101 includes, for example, a CPU, a read-only memory (ROM), a random-access memory (RAM), and an input/output control circuit (I/O control circuit). The camera microcomputer 101 includes, for example, a multiplexer, a timer circuit, and an electrically erasable programmable read-only memory (EEPROM). The camera microcomputer 101 includes, for example, an analog/digital (A/D) converter, a D/A converter, or the like. Then, the camera microcomputer 101 controls the camera strobe system by software to determine various conditions. The camera microcomputer 101 also operates as an information control unit that stores various types of information in a storage portion (an image, a RAM, or the like). The camera microcomputer 101 can communicate with the lens unit 200 via the terminal 120.

The imaging element 102 includes an infrared cut filter, a low-pass filter, or the like. The imaging element 102 is an imaging element such as a charge-coupled device (CCD) or a complementary metal-oxide-semiconductor (CMOS). An object image is formed on the imaging element 102 at the time of photographing by a lens group 202 to be described later of the imaging element 102.

The shutter 103 is movable to a position where light strikes the imaging element 102 and a position where light does not strike the imaging element 102.

An AF circuit 107 is a focus detection circuit including a distance measuring sensor having a plurality of distance measuring points. The AF circuit 107 outputs focus information such as a defocus amount of each distance measuring point. The AF circuit 107 may execute image-plane phase difference AF.

The A/D converter 109 converts the amplified analog signal output from the imaging element 102 into a digital signal.

The signal processing circuit 111 performs signal processing on image data converted into a digital signal by the A/D converter 109.

The input unit 112 includes an operation unit such as a power switch, a release switch, and a setting button. The camera microcomputer 101 executes various processing in response to an operation (input) to the input unit 112 by the user.

When the release switch is operated in one stage (half-pressed), the “switch SW1” is turned ON, and the camera microcomputer 101 starts a photographing preparation operation (focus adjustment, photometry, and the like). When the release switch is operated in two stages (fully pressed), the “switch SW2” is turned ON, and the camera microcomputer 101 starts photographing operation (exposure, development processing, and the like).

Furthermore, the user can also perform various settings of the strobe 300 attached to the camera 100 by operating a setting button or the like of the input unit 112.

The display unit 113 includes a liquid crystal device or a light-emitting element. The display unit 113 displays various set modes, other photographing information, or the like.

The posture detection circuit 140 is a circuit that detects a posture difference (change in posture) of the camera 100 from a reference posture. The posture detection circuit 140 includes a posture H detection unit 140a, a posture V detection unit 104b, and a posture Z detection unit 140c. The posture H detection unit 140a detects a posture difference of the camera 100 in the horizontal direction (H direction). The posture V detection unit 140b detects a posture difference of the camera 100 in the vertical direction (V direction). The posture Z detection unit 140c detects a posture difference of the camera 100 in the front-back direction (Z direction).

For example, an angular velocity sensor or a gyro sensor is used in the posture detection circuit 140. Posture information on the posture difference in each direction detected by the posture detection circuit 140 is output to the camera microcomputer 101.

The wireless unit 170 is a wireless communication module. The wireless unit 170 is, for example, an ultra-wideband (UWB) module, an infrared communication module, a Bluetooth (trademark) communication module, a wireless LAN communication module, a wireless USB, or the like.

The camera interface circuit 180 is a transmission/reception unit that communicates with a strobe interface circuit 3000 via the terminal 130. The camera interface circuit 180 transmits, for example, adjustment information to be described later to the strobe 300. Here, the adjustment information is information of an index when the position and setting of the strobe 300 are adjusted.

(Configuration of Lens Unit) A configuration of the lens unit 200 will be described. A lens microcomputer 201, a lens group 202, a lens drive unit 203, and an encoder 204 are included.

The lens microcomputer 201 is a microcomputer LPU (control unit) that controls each unit of the lens unit 200. The lens microcomputer 201 is, for example, a one-chip IC circuit incorporating a microcomputer. The lens microcomputer 201 includes a CPU, a ROM, a RAM, an input/output control circuit (I/O control circuit), a multiplexer, a timer circuit, an EEPROM, an A/D converter, a D/A converter, and the like.

The lens drive unit 203 is a drive system that moves the lenses included in the lens group 202. The drive amount of the lens group 202 is calculated by the camera microcomputer 101 based on the output of the AF circuit 107 in the camera 100. The information of the calculated drive amount is transmitted from the camera microcomputer 101 to the lens microcomputer 201.

The encoder 204 is an encoder that detects the position of the lens group 202 and outputs drive information. The lens drive unit 203 moves the lens group 202 by a drive amount based on the drive information from the encoder 204 to perform focus adjustment.

(Configuration of Strobe) A configuration of the strobe 300 will be described. The strobe 300 includes a battery 301, a booster circuit block 302, a trigger circuit 303, a light-emission control circuit 304, a discharge tube 305, a reflector 306, a zoom optical system 307, an integration circuit 308, and a strobe microcomputer 310. Furthermore, the strobe 300 includes an input unit 312, a display unit 313, a zoom drive circuit 330, a posture detection circuit 360, a wireless unit 370, and a strobe interface circuit 3000.

Although not illustrated in FIG. 1, the strobe 300 includes a “main body” and a “movable part”. The “main body” is detachably attached to the camera 100. The “movable part” is held so as to be rotatable in the vertical direction and the horizontal direction with respect to the “main body”.

The strobe interface circuit 3000 communicates with the camera microcomputer 101 via the terminal 130.

The battery 301 is a power source of the strobe 300.

The booster circuit block 302 includes a booster 302a, two resistors (resistors 302b and 302c) used for voltage detection, and a main capacitor 302d. The booster circuit block 302 boosts the voltage of the battery 301 to several hundred volts by the booster 302a, and accumulates electric energy for light emission in the main capacitor 302d.

The trigger circuit 303 applies a pulse voltage for exciting the discharge tube 305 to the discharge tube 305.

The light-emission control circuit 304 controls start and stop of light emission of the discharge tube 305.

The discharge tube 305 receives and excites a pulse voltage of several KV applied from the trigger circuit 303, and emits light using the electric energy charged in the main capacitor 302d.

The reflector 306 reflects light emitted from the discharge tube 305 and guides the light in a predetermined direction.

The zoom optical system 307 includes an optical panel and the like. The zoom optical system 307 is held such that a relative position with respect to the discharge tube 305 can be changed. The zoom optical system 307 can change a light amount (guide number) and an irradiation range of the strobe 300 by changing a relative position between the discharge tube 305 and the zoom optical system 307.

The drive amount of the zoom optical system 307 is calculated by the strobe microcomputer 310 based on the focal length information output from the lens microcomputer 201. Alternatively, the strobe microcomputer 310 drives the zoom optical system 307 at the position set by the input unit 312.

A light-emitting unit of the strobe 300 mainly includes a discharge tube 305, a reflector 306, and a zoom optical system 307. The irradiation range of the light-emitting unit is changed by the movement of the zoom optical system 307, and the irradiation direction of the light-emitting unit is changed by the rotation of a movable part 300b.

The integration circuit 308 monitors strobe light. The monitoring result of the strobe light is used to control the strobe 300.

The strobe microcomputer 310 is a microcomputer FPU that controls each unit of the strobe 300. The strobe microcomputer 310 is, for example, a one-chip IC circuit incorporating a microcomputer. The strobe microcomputer 310 includes, for example, a CPU, a ROM, a RAM, an input/output control circuit (I/O control circuit), a multiplexer, a timer circuit, an EEPROM, an A/D converter, a D/A converter, and the like.

The input unit 312 includes an operation unit such as a power switch, a mode setting switch for setting an operation mode of the strobe 300, and a setting button for setting various parameters. The strobe microcomputer 310 executes various processing in accordance with an input to the input unit 312. The input unit 312 also includes an operation unit for changing the setting of dimming correction of the strobe 300.

The display unit 313 includes a liquid crystal device or a light-emitting element. The display unit 313 displays each state of the strobe 300. The display unit 313 also includes an LED for displaying a warning.

The zoom drive circuit 330 includes a zoom detection unit 330a and a zoom drive unit 330b. The zoom detection unit 330a detects information about a “relative position between discharge tube 305 and zoom optical system 307” by an encoder or the like. The zoom drive unit 330b includes a motor for moving the zoom optical system 307.

The posture detection circuit 360 is a circuit that detects a posture difference (change in posture) of the movable part 300b from the reference posture. The posture H detection unit 360a detects a posture difference of the movable part 300b in the horizontal direction (H direction). The posture V detection unit 360b detects a posture difference of the movable part 300b in the vertical direction (V direction). The posture Z detection unit 360c detects a posture difference of the movable part 300b in the front-back direction (Z direction). The output of the posture detection circuit 360 is used to store the light irradiation direction of the strobe 300 and to detect the state of the stored light irradiation direction. For example, an acceleration sensor or a gyro sensor is used for the posture detection circuit 360.

The wireless unit 370 wirelessly transmits and receives data. The wireless unit 370 includes, for example, an ultra-wideband (UWB) module, an infrared communication module, a Bluetooth communication module, a wireless LAN communication module, or a wireless communication module such as wireless USB.

In the first embodiment, when the strobe 300 is a receiver strobe, the strobe 300 is disposed physically away from the camera 100. In this case, the strobe 300 is connected to the sender strobe clipped on the camera 100 via the wireless unit 370, and receives various control instructions from the sender strobe. As a result, the strobe 300 operates as a receiver strobe.

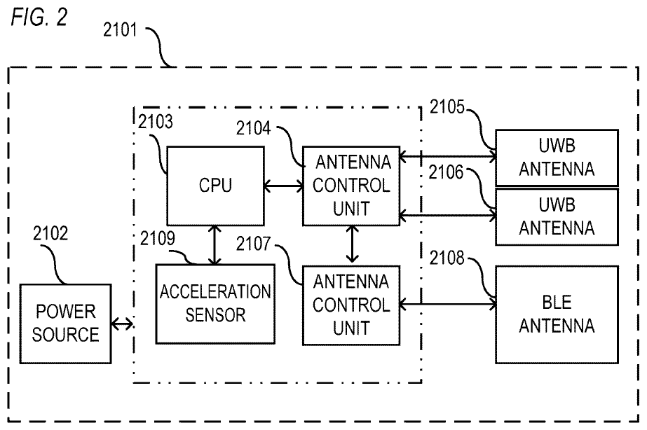

(Configuration of UWB Device) FIG. 2 is a block diagram schematically illustrating a UWB device 2101 according to the first embodiment. The UWB device 2101 is included in the wireless unit 170, the wireless unit 370, and the like in FIG. 1. That is, the camera 100 and the strobe 300 include the UWB device 2101. In addition, the UWB device 2101 may be contained in a portable small tag to provide the UWB function. In the present embodiment using an ultra-wideband (UWB) technology, a configuration of the UWB device 2101 will be described with reference to FIG. 2.

The UWB device 2101 includes a power source 2102, a CPU 2103, an antenna control unit 2104, a UWB antenna 2105, and a UWB antenna 2106. The UWB device 2101 includes an antenna control unit 2107, a Bluetooth Low Energy (BLE) antenna 2108, and an acceleration sensor 2109.

The power source 2102 supplies power to the UWB device 2101. The power source 2102 supplies power necessary for the entire operation of the UWB device 2101.

The CPU (Central Processing Unit) 2103 is in charge of logic control of the UWB device 2101. The CPU 2103 performs data processing, execution of a control sequence, and management of a communication protocol.

The antenna control unit 2104 controls the output and directivity of each of the UWB antenna 2105 and the UWB antenna 2106. In UWB communication, proper directivity of an antenna is directly linked to communication quality.

Each of the UWB antenna 2105 and the UWB antenna 2106 transmits and receives a broadband signal. UWB technology is used for highly accurate position specification. Therefore, each of the UWB antenna 2105 and the UWB antenna 2106 is specialized in transmission and reception of short pulse signals.

The antenna control unit 2107 adjusts the position and directivity of the BLE antenna 2108 to optimize communication.

The BLE antenna 2108 is used for pairing between the UWB devices 2101 and short-distance communication with a peripheral Bluetooth device. The BLE antenna 2108 optimizes signal transmission and reception of the entire UWB device 2101 in cooperation with the antenna control unit 2104.

The acceleration sensor 2109 detects the movement of the UWB device 2101 to acquire position information and vibration information of the UWB device 2101. The position information and the vibration information are used for position specification of the UWB device 2101, determination of an operation trigger, or the like.

Note that the UWB has roles as an “initiator” and a “responder”. The “initiator” has a role of transmitting a radio wave. The “responder” is a role of receiving a radio wave. The role of the UWB is dynamically determinable for each communication.

Here, in the distance measurement and angle detection, the responder receives a radio wave transmitted from the initiator, whereby the position of the UWB device 2101 can be specified. In the three-point positioning, a UWB device whose position information is known is called an “anchor”.

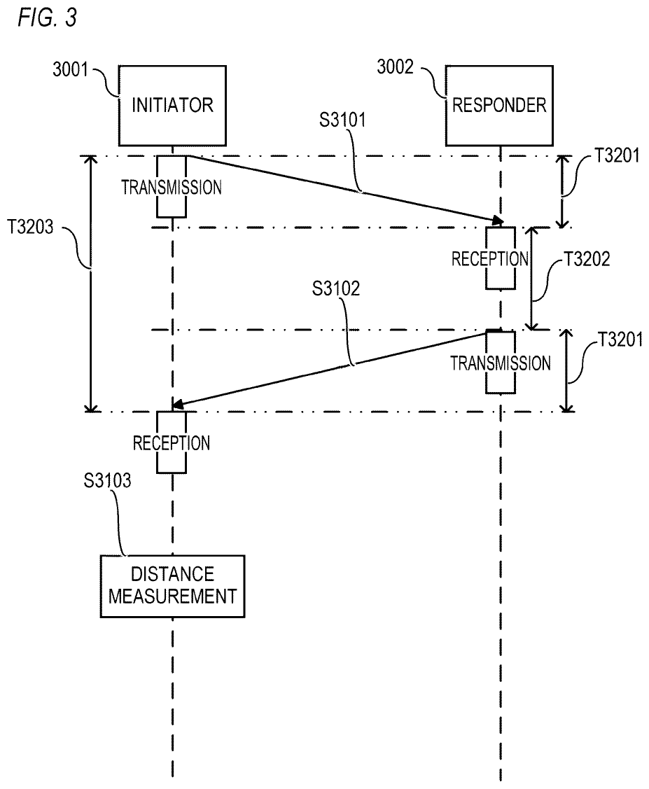

(Method of Positioning UWB Device) FIG. 3 is a sequence diagram schematically illustrating a distance measurement method using the UWB device 2101. The flow until the calculation of the distance between the two UWB devices 2101 is completed will be described with reference to FIG. 3.

Two UWB devices 2101 (initiator 3001 and responder 3002) have been set up as devices with UWB communication module and clock synchronization mechanism. When the initiator 3001 is activated, this sequence is started. In addition, the communication module of the initiator 3001 and the responder 3002 have a capability of generating and receiving a UWB pulse signal, and a clock synchronization mechanism operates.

In step S3101, the initiator 3001 generates a UWB pulse signal and transmits the UWB pulse signal to the responder 3002.

In step S3102, when receiving the pulse signal, the responder 3002 records the arrival time of the pulse signal. The responder 3002 returns the information of the arrival time to the initiator 3001.

In step S3103, the initiator 3001 measures a transmission time T3201 of each of “the pulse signal transmitted by itself” and “the response pulse signal from the responder 3002”. The transmission time T3201 represents a time from the time when the pulse signal is transmitted from the initiator 3001 to the responder 3002 to the time when the pulse signal is received by the responder 3002. The transmission time T3201 is half the time required for the pulse signal to reciprocate.

Here, “a time until the initiator 3001 transmits a pulse signal and the initiator 3001 receives the pulse signal” is a time T3203. Let “a time until the responder 3002 receives a pulse signal and responds to the initiator 3001” be the time T3202.

Then, since half of the difference between the time T3203 and the time T3202 is the transmission time T3201, the following Equation 1 is established.

$$T 3201 = 1 / {2}^{*} ( T 3203 - T 3202 ) \qquad Equation 1$$

After measuring the transmission time T3201, the initiator 3001 uses the velocity of light c to calculate the distance d between the two UWB devices 2101. Specifically, as shown in Equation 2, the distance d between the two UWB devices 2101 can be calculated by multiplying the transmission time T3201 by the velocity of light c. Here, the velocity of light c is about 299792458 meters/second.

$$Distance ( d ) = T {3201}^{*} velocity of light ( c ) \qquad Equation 2$$

As described above, the distance between the two UWB devices can be calculated.

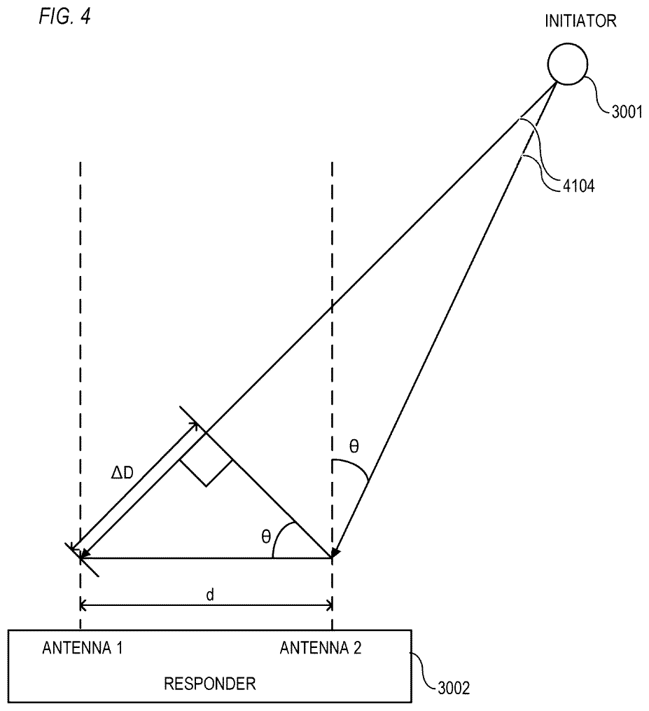

FIG. 4 is a block diagram schematically illustrating a method of detecting an angle of arrival of a tag by using a phase difference of a received signal by using two UWB devices used in the present embodiment. Hereinafter, a flow until the angle measurement is completed will be described.

The initiator 3001 and the responder 3002 are set up as devices with UWB communication module and clock synchronization mechanism. The initiator 3001 and the responder 3002 shown here are identical to the UWB modules in the wireless unit of FIG. 1.

The responder 3002 has two UWB antennas, and the antenna and the communication module communicate with the initiator 3001 and exchange information for specifying position information.
(1) First, the initiator 3001 generates a UWB signal 4104, and transmits the UWB signal 4104 to each of the two UWB antennas (antenna 1 and antenna 2).
(2) Thereafter, each of the two antennas of the responder 3002 records the arrival time of the UWB signal 4104 from the initiator 3001.

The arrival time of the UWB signal 4104 is used to calculate a phase difference φ of the received signal. The phase difference φ is used to specify a direction θ of the tag.

The wavelength λ of UWB is known. Therefore, the direction θ of the tag can be derived from the phase difference φ using the following equation. The distance d is the distance between the two antennas at the responder 3002. The path difference ΔD is a difference between a path between the antenna 1 and the initiator 3001 and a path between the antenna 2 and the initiator 3001. The direction θ is the direction θ of the initiator 3001 as viewed from the responder 3002.

$$Δ D = λ \frac{Δφ}{2 π} \qquad [ Math . 1 ]$$

$$θ = {sin}^{- 1} ( \frac{Δ D}{d} ) = {sin}^{- 1} ( \frac{λ}{2 π d} Δ φ )$$

In the present description, two UWB devices are described as an initiator and a responder, respectively. However, even in a case of three or more UWB devices, it is sufficient to designate an initiator and a responder for any two devices among the plurality of UWB devices, and the number of UWB devices is not limited.

Furthermore, which UWB device operates as an initiator may be determined on the basis of an instruction from the strobe 300 or the camera 100, or may be determined by communication between UWB devices.

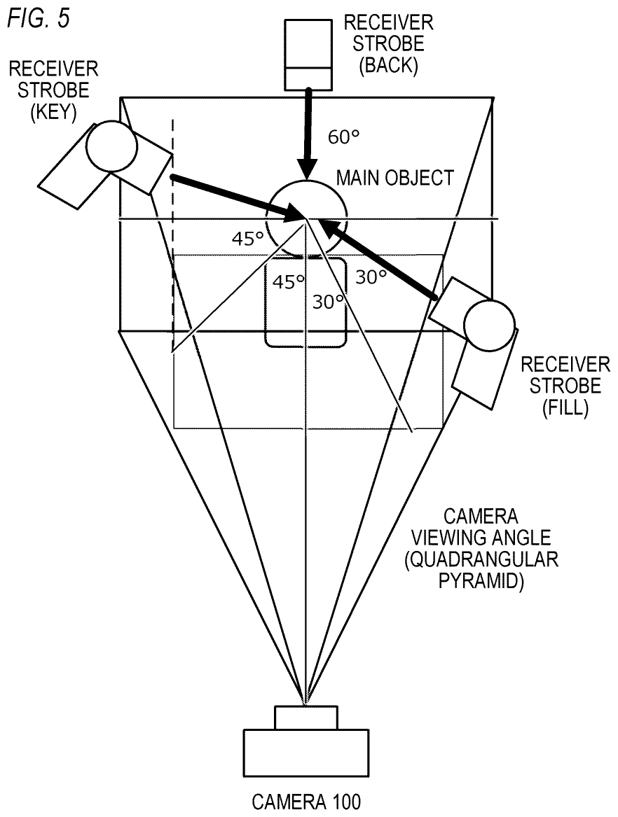

(Description of three-lamp Illumination) The three-lamp illumination will be described with reference to FIG. 5. Three-lamp illumination is generally known as a technique for obtaining suitable lighting. In the three-lamp illumination, the main object is illuminated by three lamps of a “key light that is main illumination”, a “fill light that alleviates a shadow formed by the key light”, and a “backlight that raises an outline of the main object”.

FIG. 5 illustrates a positional relationship among the camera, the main object, and the receiver strobe. In FIG. 5, the key light is disposed at a position 45° in front of the main object and at a height of 45°. The fill light is disposed at a position 30° in front of the main object and at a height of 30° on the opposite side of the key light. The backlight is disposed at a height of 60° from the rear of the main object. This angle itself is not an established and determined angle, and suitable lighting is obtained by irradiating the main object from approximately this angle.

In FIG. 5, the strobe 300 illustrated in FIG. 1 is connected to the camera 100 as a sender strobe (not illustrated). The receiver strobe of each role is a strobe having the same configuration as the strobe 300 illustrated in FIG. 1.

### First Embodiment

Hereinafter, storage and transmission of position information regarding the relative position of the receiver strobe with respect to the reference position (the position of the camera 100) in the first embodiment will be described.

The system according to the first embodiment includes “a camera 100 including a UWB device”, “a sender strobe connected to an accessory shoe unit of the camera”, “a receiver strobe including a UWB device”, and “a UWB device held by a main object”. Each of the sender strobe and the receiver strobe is a strobe 300.

The receiver strobe is placed at a position away from the camera 100. The light emission of the receiver strobe is wirelessly controlled by the sender strobe. The sender strobe does not emit light and performs only control of the receiver strobe. Therefore, instead of the sender strobe, a device (strobe transmitter or the like) that does not emit light but can control the receiver strobe can be used.

First, the position information of the receiver strobe will be described. As illustrated in FIG. 5, after the user finishes disposing the receiver strobe, the user actually performs photographing. Conventionally, various kinds of information (camera model name, lens model name, setting related to photographing, and the like) are stored as metadata in an image. Therefore, at the time of photographing or storing an image, the camera microcomputer 101 stores the position information of the receiver strobe as metadata in the image. In this case, only the position information of the receiver strobe at the time of the last (most recent) photographing may be sequentially overwritten and stored. Furthermore, the position information of the receiver strobe may be stored at the time when the operation for “storing the position information of the receiver strobe” is performed. The operation for “storing the position information of the receiver strobe” is, for example, an operation on the camera 100 or the sender strobe. In addition to the acquired image, setting values of the camera 100 or the sender strobe may be stored in the metadata.

The position information of the receiver strobe includes not only information on the distance/angle (distance and angle) between the camera 100 and the receiver strobe but also information on the distance/angle between the camera 100 and the main object and optical axis information of the receiver strobe. Regarding the optical axis information of the receiver strobe, in a case where there is a difference between “the direction from the receiver strobe to the UWB device (object) held by the main object” and “the direction of the optical axis”, information on the difference is also stored.

Further, the setting information of the receiver strobe at the time of photographing is stored in the storage portion (an image, a storage medium of the camera 100, or the like) together with the position information of the receiver strobe. The setting information of the receiver strobe includes a role, information of a model of the receiver strobe, series information, a light emission amount (guide number), a light distribution angle, and information of a posture of the strobe (which posture is a normal position or a vertical position). Note that the information on the posture of the strobe is unnecessary when the light distribution is round. This is because if the light distribution is round, the concept of the normal position and the vertical position cannot be assumed.

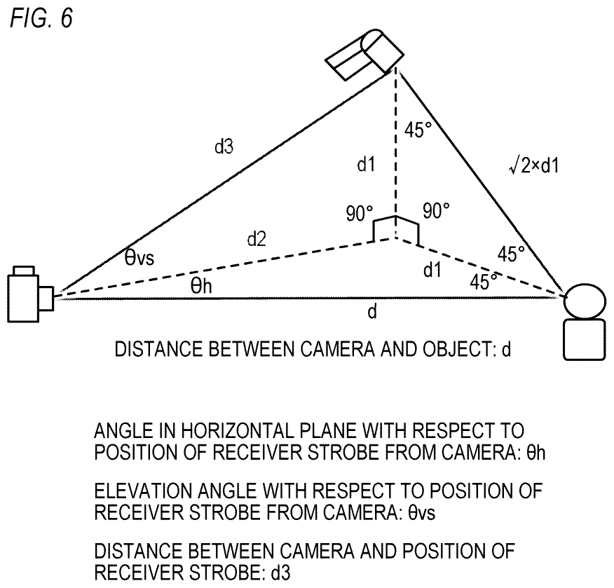

An example of the position information in a case where the key light is used will be described with reference to FIG. 6. The position information includes information such as an angle θh, an angle θvs, and a distance d3. The angle θh is an angle (horizontal angle in the horizontal plane) formed by the “optical axis (direction of the optical axis) of the camera 100” and the “straight line (direction) from the camera 100 to the receiver strobe” in the horizontal plane. The angle θvs is an elevation angle from the camera 100 to the position of the receiver strobe. The distance d3 is a distance from the camera 100 to the receiver strobe. In addition, in a case where the optical axis of the receiver strobe is directed to the UWB device held by the main object, the fact is held as optical axis information. Furthermore, in a case where some correction has been made to the optical axis of the receiver strobe, the correction amount from the direction with respect to the UWB device is held in addition to the optical axis information. For example, the correction amount is 5° above the direction relative to the UWB device, etc.

In FIG. 6, a UWB device (hereinafter, referred to as a “holding device”) held by the main object (disposed on the main object) is located at the optical axis center of the camera 100. Therefore, regarding the distance/angle between the camera 100 and the main object, the angle (horizontal angle) formed by the “optical axis of the camera 100” and the “straight line from the camera 100 to the holding device” in the horizontal plane is 0°. Furthermore, regarding the distance/angle between the camera 100 and the main object, the elevation angle with respect to the position of the holding device from the camera 100 is 0°, and the distance between the camera 100 and the holding device is d.

The camera microcomputer 101 communicates with the UWB device of the receiver strobe, and performs distance measurement and angle detection to calculate the distance/angle between the camera 100 and the receiver strobe. Furthermore, the camera microcomputer 101 communicates with the holding device to perform distance measurement and angle detection, thereby calculating the distance/angle between the camera 100 and the main object.

In addition, the strobe microcomputer 310 communicates with the holding device to perform distance measurement and angle detection, thereby calculating the direction of the optical axis of the receiver strobe. In general, the optical axis of the receiver strobe is directed to the UWB device held by the main object. However, since the direction of the optical axis of the receiver strobe may be adjusted by the user, the direction needs to be stored. The strobe microcomputer 310 transmits information on the angle between the calculated direction of the optical axis and the direction to the holding device with respect to the camera 100 to the sender strobe. When the sender strobe communicates with the camera 100, the camera microcomputer 101 obtains information on the optical axis of the receiver strobe.

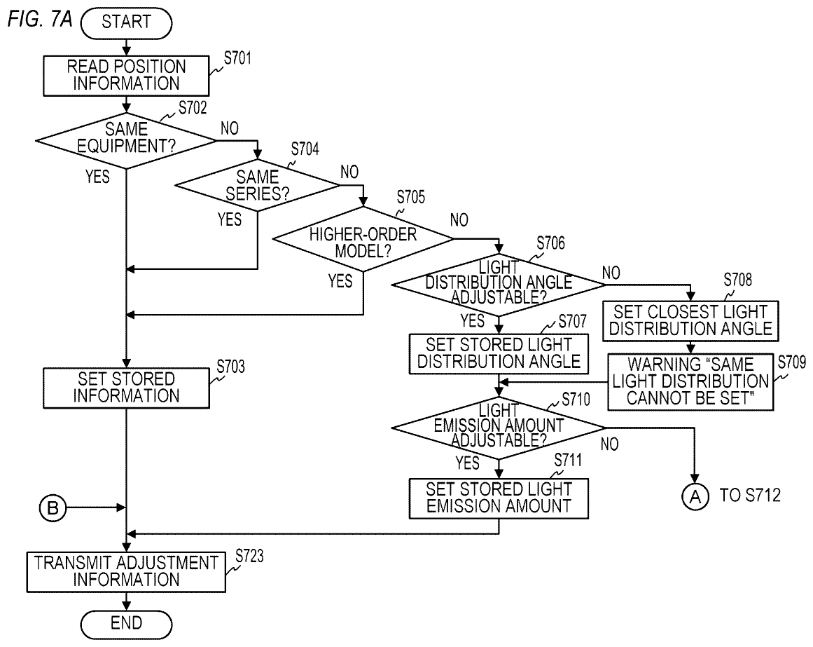

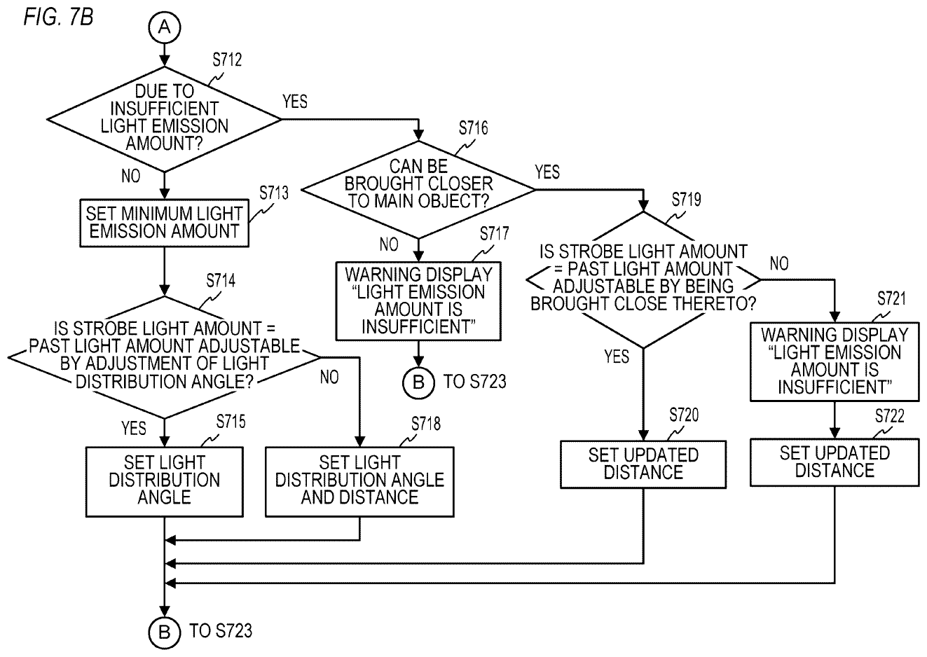

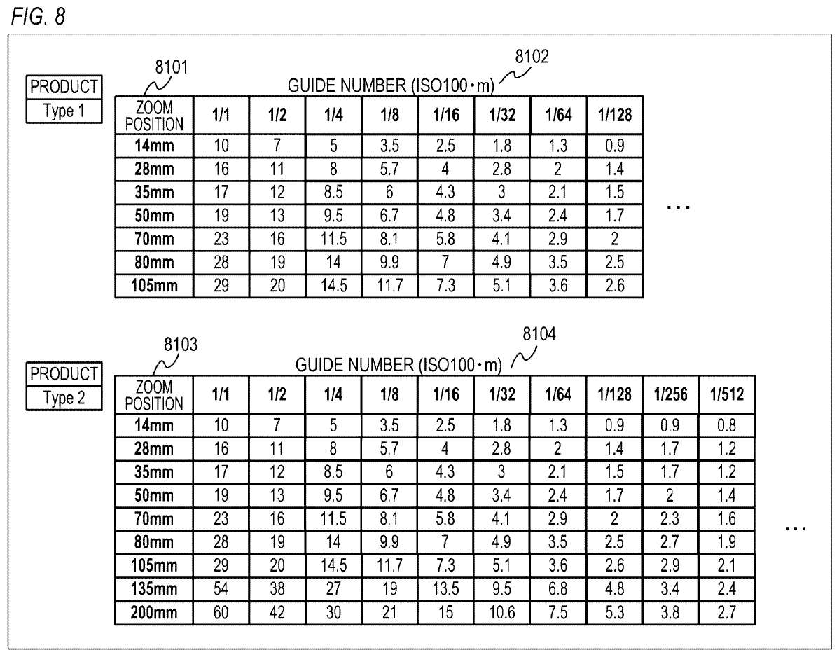

Next, with reference to the flowcharts of FIGS. 7A and 7B, processing for transmitting information based on past equipment (receiver strobe) position information as the strobe 300 to the receiver strobe will be described. In the flowcharts of FIGS. 7A and 7B, the camera microcomputer 101 holds a setting value table (see FIG. 8) in which information related to the setting of the strobe is described, and the processing is performed with reference to the setting value table.

Note that it is assumed that the sender strobe clipped on the camera 100 at the start time point of the flowchart of FIG. 7A has already established wireless connection with the receiver strobe.

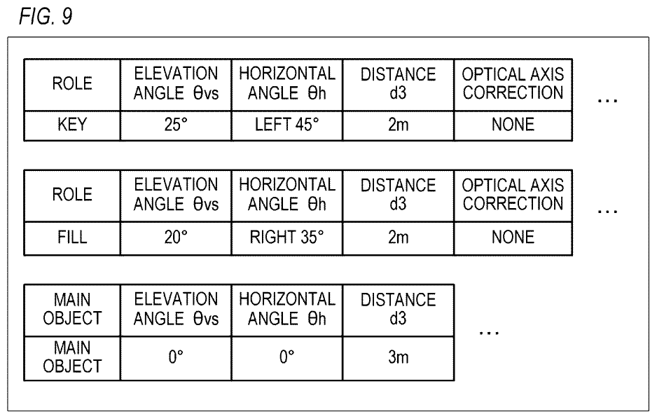

In step S701, the camera microcomputer 101 selects and reads position information (position information at the time of past imaging) of the receiver strobe (hereinafter, referred to as “past equipment”) stored in the camera 100. In addition, the camera microcomputer 101 displays “distance/angle between the camera 100 and the receiver strobe, distance/angle between the camera 100 and the main object, and optical axis information of the receiver strobe”, which is the position information of the past equipment, on the display unit 113 or the display unit 313. At this time, a diagram showing the layout in the three-dimensional space as shown in FIG. 6 may be displayed, or a table of numerical values as shown in FIG. 9 may be displayed.

In step S702, the camera microcomputer 101 communicates with the strobe microcomputer 310 of the currently connected receiver strobe, and determines whether or not the receiver strobe is the same as the past equipment. If it is determined that the receiver strobe is the same as the past equipment, it is determined that the same setting as the past equipment is also applicable to the receiver strobe, and the processing proceeds to step S703. On the other hand, when it is determined that the receiver strobe is not the same as the past equipment, the processing proceeds to step S704. Note that the determinations in steps S702, S704, and S705 are made on the basis of the information on the model of the past equipment and the information on the model of the receiver strobe.

In step S703, the camera microcomputer 101 sets the setting information and the position information of the past equipment stored in the camera 100 as the adjustment information. Here, the adjustment information is information of an index when the position and setting of the receiver strobe are adjusted in the receiver strobe. The adjustment information is information based on the setting information and position information of the past equipment at the time of past photographing (at the time of imaging). When the processing in step S703 is completed, the camera microcomputer 101 transmits the adjustment information to the receiver strobe in step S723 described later.

In this case, it is determined that the same setting as the setting of the past equipment at the time of past photographing can be applied also to the receiver strobe by the determination in steps S702, S704, and S705. Therefore, when receiving the adjustment information, the receiver strobe applies the adjustment information (setting information and position information) to itself. Specifically, the receiver strobe adjusts its own setting so as to emit light at the light emission amount and the light distribution angle of the past equipment at the time of past photographing. Then, the receiver strobe displays, on the display unit 313, guidance for adjusting the position and posture of the receiver strobe to the position and posture corresponding to the position information of the past equipment. As a result, the user adjusts the receiver strobe to the position and posture corresponding to the position information according to the guidance. As described above, the receiver strobe can control its own light emission so as to obtain the same illumination effect as in the case where the past equipment has emitted light from the past position.

In step S704, the camera microcomputer 101 determines whether or not the connected receiver strobe is in the same series as the past equipment. If it is determined that the receiver strobe is the same series as the past equipment, it is determined that the same setting as the past equipment is also applicable to the receiver strobe, and the processing proceeds to step S703. When it is determined that the receiver strobe is not in the same series as the past equipment, the processing proceeds to step S705.

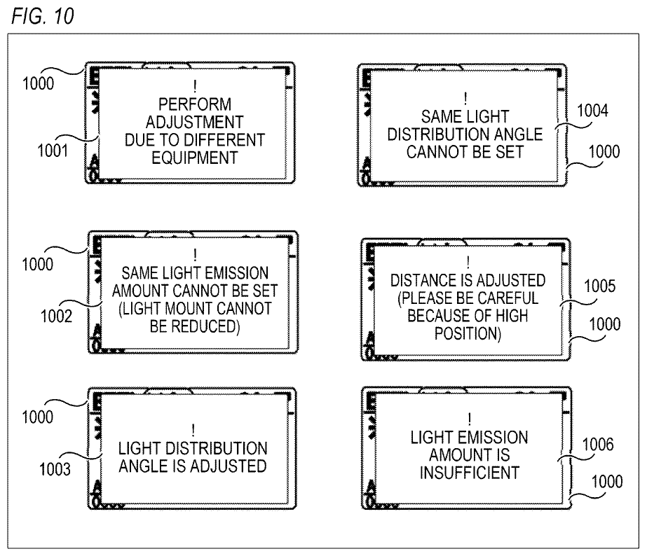

In step S705, first, the camera microcomputer 101 sets the setting information and the position information of the past equipment stored in the camera 100 as the adjustment information. Thereafter, the camera microcomputer 101 determines whether or not the receiver strobe is a higher-order model of the past equipment. When it is determined that the receiver strobe is not a higher-order model of the past equipment, the camera microcomputer 101 displays a display item 1001 (display item indicating adjustment to be performed due to different equipment from past equipment) illustrated in FIG. 10 on the display unit 1000. In this case, the processing proceeds to step S706. Note that the display unit 1000 is the display unit 113 of the camera 100 or the display unit 313 of the sender strobe. In the following, explanation will be given assuming that the display unit 1000 is the display unit 113. If it is determined that the receiver strobe is not the same as the past equipment but is a higher-order model of the past equipment, it is determined that the same setting as the past equipment is also applicable to the receiver strobe, and the processing proceeds to step S703.

In step S706, the camera microcomputer 101 determines whether or not the light distribution angle of the receiver strobe can be adjusted to be the same as the light distribution angle set for the past equipment at the time of photographing (=the light distribution angle stored in the setting information). When it is determined that the light distribution angle of the receiver strobe can be adjusted to be the same as the light distribution angle set for the past equipment, the processing proceeds to step S707. When it is determined that the light distribution angle of the receiver strobe cannot be adjusted to be the same as the light distribution angle set for the past equipment, the processing proceeds to step S708.

In step S707, the camera microcomputer 101 sets (resets) the stored information on the light distribution angle of the past equipment as the information on the light distribution angle in the adjustment information.

In step S708, the camera microcomputer 101 sets the information on the light distribution angle closest to the light distribution angle of the past equipment among the light distribution angles that can be set in the receiver strobe as the information on the light distribution angle in the adjustment information.

In step S709, the camera microcomputer 101 displays, on the display unit 1000, a warning that “the same light distribution cannot be set” for the past equipment in the receiver strobe. For example, the camera microcomputer 101 displays the display item 1004 illustrated in FIG. 10 on the display unit 1000.

In step S710, the camera microcomputer 101 determines whether or not the light emission amount of the receiver strobe can be adjusted to the light emission amount of the past equipment at the time of photographing (=the light emission amount stored in the setting information). In a case where it is determined that the light emission amount of the receiver strobe can be adjusted to the light emission amount of the past equipment, the processing proceeds to step S711. In a case where it is determined that the light emission amount of the receiver strobe cannot be adjusted to the light emission amount of the past equipment, the processing proceeds to step S712.

In step S711, the camera microcomputer 101 sets (resets) the stored information on the light emission amount of the past equipment as the information on the light emission amount in the adjustment information.

In step S712, the camera microcomputer 101 determines whether or not the reason why the light emission amount of the receiver strobe cannot be adjusted to the light emission amount of the past equipment is due to an insufficient light emission amount of the receiver strobe. In a case where it is determined that the light emission amount of the receiver strobe cannot be adjusted to the light emission amount of the past equipment due to the insufficient light emission amount of the receiver strobe (small setting value of the maximum light emission amount of the receiver strobe), the processing proceeds to step S716. In a case where it is determined that the light emission amount of the receiver strobe cannot be adjusted to the light emission amount of the past equipment due to large setting value of the minimum light emission amount, the processing proceeds to step S713.

In step S713, the camera microcomputer 101 sets information on the minimum light emission amount of the receiver strobe (the minimum value among the settable light emission amounts) as information on the light emission amount in the adjustment information. In addition, the camera microcomputer 101 displays the display item 1002 illustrated in FIG. 10 on the display unit 1000. The display item 1002 indicates that the receiver strobe cannot be set to the same light emission amount as the previous time.

In step S713, the camera microcomputer 101 simultaneously calculates the distance between the receiver strobe and the camera 100. Furthermore, in a case where the height of the position where the receiver strobe is installed is too high, for example, more than 2 m, the camera microcomputer 101 gives attention (warning) such as “Please be careful because of the high position”. For example, the camera microcomputer 101 displays the display item 1005 illustrated in FIG. 10 on the display unit 1000.

Furthermore, in a case where the distance between the receiver strobe and the camera 100 is not sufficiently long, the camera microcomputer 101 displays a message such as “The light emission amount is large”. For example, the camera microcomputer 101 displays the display item 1002 illustrated in FIG. 10 on the display unit 1000.

In step S714, if the light distribution angle of the receiver strobe is adjusted, the camera microcomputer 101 determines whether or not the amount of irradiation light from the past equipment at the time of past photographing hitting the main object can be matched with the amount of irradiation light from the receiver strobe hitting the main object. In a case where it is determined that the amount (hereinafter, referred to as “past light amount”) of the irradiation light from the past equipment hitting the main object can be matched with the amount (hereinafter, referred to as “strobe light amount”) of the irradiation light from the receiver strobe hitting the main object, the processing proceeds to step S715. In a case where it is determined that the strobe light amount cannot be matched with the past light amount, the processing proceeds to step S718.

In step S715, the camera microcomputer 101 calculates the light distribution angle of the receiver strobe such that the strobe light amount matches the past light amount in a case where the light emission amount of the receiver strobe is the minimum light emission amount. Then, the camera microcomputer 101 sets (resets) the information on the calculated light distribution angle as information on the light distribution angle in the adjustment information. In addition, the camera microcomputer 101 displays the display item 1003 illustrated in FIG. 10 on the display unit 1000. The display item 1003 indicates that the light distribution angle has been adjusted.

In step S716, the camera microcomputer 101 determines whether or not the receiver strobe can be brought closer to the main object outside the viewing angle of the camera 100. In a case where it is determined that “the arrangement position of the receiver strobe is just outside the viewing angle of the camera 100, and the receiver strobe cannot be brought closer to the main object than now”, the processing proceeds to step S717. In a case where it is determined that the receiver strobe can be brought closer to the main object outside the viewing angle of the camera 100, the processing proceeds to step S719.

In step S717, the camera microcomputer 101 displays a warning such as “the light emission amount is insufficient” on the display unit 1000. For example, the camera microcomputer 101 displays the display item 1006 illustrated in FIG. 10 on the display unit 1000.

In step S718, the camera microcomputer 101 calculates the widest angle of the light distribution angle of the receiver strobe. Then, when the light distribution angle of the receiver strobe is the widest angle, the camera microcomputer 101 calculates the distance between the camera 100 and the receiver strobe such that the past light amount matches the strobe light amount. The camera microcomputer 110 sets (resets) the calculated widest angle information and distance information as light distribution angle information and distance information (distance information between the camera 100 and the receiver strobe) in the adjustment information.

In step S719, if the receiver strobe is brought close to the main object outside the viewing angle of the camera 100, the camera microcomputer 101 determines whether or not the strobe light amount can be adjusted to the past light amount. In a case where it is determined that the strobe light amount can be adjusted to the past light amount if the receiver strobe is brought close to the main object, the processing proceeds to step S720. In a case where it is determined that the strobe light amount cannot be adjusted to the past light amount even if the receiver strobe is brought close to the main object, the processing proceeds to step S721.

In step S720, the camera microcomputer 101 calculates the distance between the camera 100 and the receiver strobe such that the past light amount matches the strobe light amount. The camera microcomputer 101 sets the information on the calculated distance as distance information in the adjustment information.

In step S721, the camera microcomputer 101 displays a warning such as “the light emission amount is insufficient” on the display unit 1000.

In step S722, the camera microcomputer 101 calculates the distance between the camera 100 and the receiver strobe when the receiver strobe is closest to the main object outside the viewing angle of the camera 100. The camera microcomputer 101 sets the information on the calculated distance as distance information in the adjustment information.

In step S723, the camera microcomputer 101 transmits the adjustment information to the receiver strobe. As a result, the receiver strobe performs setting according to the received adjustment information. Furthermore, the receiver strobe requests the user to adjust the position and posture of the receiver strobe on the basis of, for example, distance/angle information included in the received adjustment information. As a result, an illumination effect similar to that when the past equipment illuminates the object can be realized by the receiver strobe. Note that the camera 100 stores information of brightness of ambient light, weather information, or the like at the time of using the past equipment, and the adjustment information may also include these pieces of information.

According to the processing of the flowcharts in FIGS. 7A and 7B, in a case where the same setting as the setting of the past equipment is possible for the currently used receiver strobe, the camera 100 transmits the position information and the setting information of the past equipment to the receiver strobe as the adjustment information. As a result, the receiver strobe itself or the user can adjust the receiver strobe to the same setting and the same position as the past equipment at the time of past photographing with reference to the adjustment information.

On the other hand, in a case where the same setting as the setting of the past equipment at the time of the past photographing is not possible for the currently used receiver strobe, the camera 100 adjusts (changes) the adjustment information including the position information and the setting information of the past equipment, and then transmits the adjustment information to the receiver strobe. Specifically, information obtained by adjusting at least one of the position information and the setting information is transmitted as the adjustment information such that the amount of light hitting the main object from the past equipment at the past photographing time coincides with (or approaches) the amount of light hitting the main object from the receiver strobe. Here, assuming a case where the amount of light emitted from the past equipment and hitting the object is made to coincide with the amount of light emitted from the receiver strobe and hitting the object. The adjustment information includes, for example, information obtained by adjusting the information on the light emission amount and the light distribution angle in the setting information so as to correspond to (or be closest to) the information on the light emission amount and the light distribution angle of the receiver strobe in this case. The adjustment information includes, for example, information obtained by adjusting the information on the distance between the past equipment and the camera 100 in the position information so as to correspond to (or be closest to) the information on the distance between the receiver strobe and the camera 100 in this case.

As a result, the receiver strobe can be adjusted by the receiver strobe itself or the user with reference to the adjustment information so as to obtain the same effect as the case where the past equipment irradiated the main object with light at the past time. In this case, the camera microcomputer 101 may notify that at least one (adjustment information) of the position information and the setting information has been adjusted. The camera microcomputer 101 may issue a warning when the information of the light emission amount is different by more than a predetermined amount before and after the adjustment of the adjustment information. Further, when the height of the position of the receiver strobe corresponding to the adjustment information exceeds a predetermined height (for example, 2 m), the camera microcomputer 101 may give attention (warning) such as “Please be careful because of the high position”.

FIG. 8 is a setting value table describing information related to the setting of the strobe in the present embodiment. In the setting value table, a list of main specifications such as zoom positions 8101 and 8103 and guide numbers 8102 and 8104 for each type name is described as metadata. The setting value table is recorded in a ROM that is a recording medium of the camera 100 or the strobe 300.

FIG. 9 illustrates a setting value table describing position information of the receiver strobe according to the present embodiment. For each strobe, together with the role, information (information such as elevation angle, horizontal angle, and distance) related to the arrangement based on the position and posture of the camera 100 is described by metadata. The setting value table is recorded in a ROM that is a recording medium of the camera 100 or the strobe 300. The information in the setting value table is updated each time arrangement is performed.

According to the first embodiment, consistency regarding arrangement and setting of the receiver strobe for each photographing is improved. In addition, by a general user using information stored in an image captured by a professional, it is possible to easily reproduce the arrangement, setting, and the like of the receiver strobe “without repeating trial and error by estimating the position of the light source as in the conventional case”.

### Second Embodiment

In a second embodiment, a case where the camera 100 does not include a UWB device, and the sender strobe and the receiver strobe include a UWB device will be described. The configuration of the strobe 300 is the same as that of the first embodiment, but there is difference that there is no UWB device in the configuration of the camera 100. Detailed description of each configuration of the camera strobe system according to the second embodiment will be omitted.

In the first embodiment, the camera 100 performs processing of storing position information of the receiver strobe and processing of transmitting the position information to the receiver strobe. In the second embodiment, the sender strobe performs these processing. The processing flow is substantially the same as that in the first embodiment. The second embodiment is different from the first embodiment only in that the sender strobe transmits the position information of the main object and the position information of the receiver strobe to the camera 100 when the position information is stored in the image. Even in a case where the camera 100 does not have the UWB device, the camera strobe system having the “sender strobe, receiver strobe, and holding device” can store the position information of the receiver strobe and transmit the position information to the receiver strobe for rearrangement.

Therefore, in the second embodiment, the position information illustrated in FIG. 9 is not based on the position and posture of the camera 100, but is replaced with information based on the position and posture of the sender strobe.

Instead of the camera 100, another device including a wireless module may display a “guide in which the strobe installation position is superimposed in real time in the image acquired by the camera 100”. In this case, when position information, strobe shape information, and the like are transmitted from the camera 100 or the sender strobe/strobe transmitter to another device, the other device may generate and display the above guide.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is equal to or smaller than B, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. For this reason, unless there is a contradiction, “A or more” may be read as “larger (higher; longer; more) than A”, and “A or less” may be read as “smaller (lower; shorter; less) than A”. Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to provide a technique for more faithfully reproducing an effect by light emission of past strobe on an object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-193615, filed Nov. 5, 2024, which is hereby incorporated by reference herein in its entirety.

What is claimed is:

1. A system that controls a first strobe that irradiates an object imaged by an imaging device with light, the system comprising:
a processor; and
a memory storing a program which, when executed by the processor, causes the system to:
execute information control processing for storing, in a storage portion, position information regarding a position of a second strobe and setting information of the second strobe in a case where the imaging device is performing imaging using light emitted from the second strobe at a first time; and
execute transmission processing for transmitting, to the first strobe, information based on the position information and the setting information stored in the storage portion in a case where the first strobe irradiates the object with light at a second time after the first time.

2. The system according to claim 1, wherein
in the transmission processing, in a first case where it is determined that a same setting as the setting of the second strobe at the first time is possible for the first strobe, first information, including the position information and the setting information stored in the storage portion, is transmitted to the first strobe.

3. The system according to claim 2, wherein
in the transmission processing, in a second case where it is determined that the same setting as the setting of the second strobe at the first time is not possible for the first strobe, second information obtained by adjusting the first information is transmitted to the first strobe.

4. The system according to claim 3, wherein
the second information is information obtained by adjusting the first information so as to correspond to the position and setting of the first strobe in a third case, and
the third case is a case where an amount of light emitted from the first strobe and hitting the object is made to coincide with an amount of light emitted from the second strobe and hitting the object at the first time.

5. The system according to claim 4, wherein
the setting information includes information of a light emission amount and a light distribution angle, and
the second information includes information obtained by adjusting information of a light emission amount and a light distribution angle in the setting information into information of a light emission amount and a light distribution angle of the first strobe in the third case.

6. The system according to claim 4, wherein
the position information includes information on a distance between the second strobe and the imaging device, and
the second information includes information obtained by adjusting information on a distance between the second strobe and the imaging device in the position information into information of a distance between the first strobe and the imaging device in the third case.

7. The system according to claim 3, wherein the program which, when executed by the processor, further causes the system to execute notification processing for notifying that the first information has been adjusted, in the second case.

8. The system according to claim 3, wherein
the setting information includes information of a light emission amount, and
the program which, when executed by the processor, further causes the system to execute warning processing for issuing a warning in a case where the information of the light emission amount is different between the first information and the second information by more than a predetermined amount.

9. The system according to claim 3, wherein the program which, when executed by the processor, further causes the system to execute warning processing for issuing a warning in a case where a height of a position of the first strobe corresponding to the second information is larger than a predetermined height in the second case.

10. The system according to claim 2, wherein the program which, when executed by the processor, further causes the system to execute determination processing for determining whether or not the same setting as the setting of the second strobe at the first time is possible in the first strobe on a basis of model information of the first strobe and model information of the second strobe.

11. The system according to claim 1, wherein
the position information includes 1) a distance and an angle between the imaging device and the second strobe, 2) a distance and an angle between the imaging device and the object, and 3) information of an optical axis of the second strobe.

12. The system according to claim 11, wherein
the information of the optical axis of the second strobe also includes information regarding a difference between a direction from the second strobe to the object and a direction of the optical axis of the second strobe.

13. The system according to claim 1, wherein
the setting information includes at least one of a role, a light distribution angle, a light emission amount, and a model name.

14. The system according to claim 13, wherein
the setting information includes posture information indicating whether or not the posture of the second strobe is at a normal position or a vertical position in a case where the light distribution of the second strobe is not a round light distribution.

15. The system according to claim 1, further comprising
the imaging device, wherein
the imaging device executes the information control processing and the transmission processing.

16. A system that controls a first strobe that irradiates an object imaged by an imaging device with light, the system comprising:
a processor; and
a memory storing a program which, when executed by the processor, causes the system to:
execute information control processing for storing, in a storage portion, position information regarding a relative position of a second strobe with respect to a reference position in a case where the imaging device is performing imaging using light emitted from the second strobe at a first time; and
execute transmission processing for transmitting information based on the position information stored in the storage portion to the first strobe in a case where the first strobe irradiates the object with light at a second time after the first time.

17. A control method of a system that controls a first strobe that irradiates an object imaged by an imaging device with light, the control method comprising:
storing, in a storage portion, position information regarding a position of a second strobe and setting information of the second strobe when the imaging device is performing imaging using light emitted from the second strobe at a first time; and
transmitting, to the first strobe, information based on the position information and the setting information stored in the storage portion in a case where the first strobe irradiates the object with light at a second time after the first time.

18. A control method of a system that controls a first strobe that irradiates an object imaged by an imaging device with light, the control method comprising:
storing, in a storage portion, position information regarding a relative position of a second strobe with respect to a reference position when the imaging device is performing imaging using light emitted from the second strobe at a first time; and
transmitting information based on the position information stored in the storage portion to the first strobe when the first strobe irradiates the object with light at a second time after the first time.

19. A non-transitory computer readable medium that stores a program, wherein the program causes a computer to execute a control method of a system that controls a first strobe that irradiates an object imaged by an imaging device with light, the control method comprising:
storing, in a storage portion, position information regarding a position of a second strobe and setting information of the second strobe when the imaging device is performing imaging using light emitted from the second strobe at a first time; and
transmitting, to the first strobe, information based on the position information and the setting information stored in the storage portion in a case where the first strobe irradiates the object with light at a second time after the first time.

20. A non-transitory computer readable medium that stores a program, wherein the program causes a computer to execute a control method of a system that controls a first strobe that irradiates an object imaged by an imaging device with light, the control method comprising:
storing, in a storage portion, position information regarding a relative position of a second strobe with respect to a reference position when the imaging device is performing imaging using light emitted from the second strobe at a first time; and
transmitting information based on the position information stored in the storage portion to the first strobe when the first strobe irradiates the object with light at a second time after the first time.
